(19) United States
(12) Patent Application Publication
(10) Pub. No.: US 2025/0273805 A1
(43) Pub. Date: Aug. 28, 2025

(54) ELECTRIC STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio Mori, Toyota-shi (JP); Yoshiro Kamo, Ashigarakami-gun (JP); Takahiko Nakano, Nagoya-shi (JP); Toshihiro Shimonaka, Toyota-shi (JP); Kenichi Kohashi, Sunto-gun (JP); Yuki Soda, Nagoya-shi (JP)

(73) Assignee: TOYOTA JIDOSHA KABUSHIKI KAISHA, Toyota-shi (JP)

(21) Appl. No.: 18/969,775

(22) Filed: Dec. 5, 2024

(30) Foreign Application Priority Data
Feb. 22, 2024 (JP) 2024-025339

(51) Int. Cl. H01M 50/342; B60L 50/64; H01M 50/209

(52) U.S. Cl. CPC H01M 50/3425; B60L 50/64; H01M 50/209; H01M 2220/20

(57) ABSTRACT

An electric storage device includes a plurality of electric storage cells and a housing case. Each of the plurality of electric storage cells includes a cell exhaust valve that is provided on a side surface of the electric storage cell and exhausts gas in the electric storage cell. The housing case includes a lower case, an upper case, and a case exhaust valve. The case exhaust valve is provided above or below the center of the housing case in the height direction. When the case exhaust valve is provided above the center of the housing case, the cell exhaust valve is provided above the center of the electric storage cell in the height direction. When the case exhaust valve is provided below the center of the housing case, the cell exhaust valve is provided below the center of the electric storage cell in the height direction.

### CROSS-REFERENCE TO RELATED APPLICATION

This application claims priority to Japanese Patent Application No. 2024-025339 filed on Feb. 22, 2024, incorporated herein by reference in its entirety.

### BACKGROUND

### 1. Technical Field

The present disclosure relates to an electric storage device.

### 2. Description of Related Art

Japanese Unexamined Patent Application Publication No. 2023-17448 discloses a battery pack in which a terminal and an exhaust valve that exhausts gas in a battery cell are provided at the top of the battery cell, and the gas discharged from the exhaust valve is discharged from a gas exhaust duct provided at the top of the battery pack.

### SUMMARY

There may be an instance where a battery cell with an exhaust valve provided on a side surface of the battery cell is housed in a battery pack. In such an instance, when the gas exhaust duct is provided at the top of the battery pack, the distance between the exhaust valve and the gas exhaust duct may be great that the exhaust efficiency is reduced. An improvement in the exhaust efficiency has been required in an electric storage device that houses an electric storage cell with an exhaust valve provided on a side surface of the electric storage cell.

One object of the present disclosure is to improve the exhaust efficiency in an electric storage device that houses an electric storage cell with a cell exhaust valve provided on a side surface of the electric storage cell.

An electric storage device according to an aspect of the present disclosure includes a plurality of electric storage cells and a housing case that houses the plurality of electric storage cells. Each of the plurality of electric storage cells includes a cell exhaust valve that is provided on a side surface of the electric storage cell and exhausts gas in the electric storage cell. The housing case includes a lower case, an upper case, and a case exhaust valve that exhausts gas in the housing case. The case exhaust valve is provided above or below the center of the housing case in the height direction. When the case exhaust valve is provided above the center of the housing case, the cell exhaust valve is provided above the center of the electric storage cell in the height direction. When the case exhaust valve is provided below the center of the housing case, the cell exhaust valve is provided below the center of the electric storage cell in the height direction.

Preferably, the case exhaust valve is provided above the center of the lower case or in the upper case, and the cell exhaust valve is provided above the center of the electric storage cell in the height direction.

Preferably, the case exhaust valve is provided below the center of the lower case, and the cell exhaust valve is provided below the center of the electric storage cell in the height direction.

Preferably, the electric storage device is installed in a vehicle. Each of the plurality of electric storage cells includes an upper surface, a lower surface, a pair of short side surfaces, and a pair of long side surfaces. The pair of long side surfaces is disposed with an interval in the width direction of the vehicle. Each of the pair of long side surfaces is formed to extend in the front-rear direction of the vehicle. The pair of short side surfaces is provided with an interval in the front-rear direction of the vehicle. The cell exhaust valve is provided on one surface of the pair of short side surfaces.

Preferably, the electric storage device is installed in a vehicle. Each of the plurality of electric storage cells includes an upper surface, a lower surface, a pair of short side surfaces, and a pair of long side surfaces. The pair of long side surfaces is disposed with an interval in the front-rear direction of the vehicle. Each of the pair of long side surfaces is formed to extend in the width direction of the vehicle. The pair of short side surfaces is provided with an interval in the width direction of the vehicle. The cell exhaust valve is provided on one surface of the pair of short side surfaces.

Preferably, the lower surface and the lower case are secured by an adhesive.

According to the present disclosure, the exhaust efficiency is improved in an electric storage device that houses an electric storage cell with a cell exhaust valve provided on a side surface of the electric storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an electric storage device according to a first embodiment;

FIG. 2 is a view schematically illustrating an example of an electric storage cell 10;

FIG. 3 is a view schematically illustrating a cross section of an electric storage device 1 when the electric storage device 1 is cut in a plane passing through a case exhaust valve 23 and parallel to a short side surface 13 of the electric storage cell 10;

FIG. 4 is a perspective view schematically illustrating an electric storage device according to a second embodiment;

FIG. 5 is a perspective view schematically illustrating an electric storage device according to a third embodiment;

FIG. 6 is a view schematically illustrating an example of an electric storage cell 10B;

FIG. 7 is a perspective view schematically illustrating an electric storage device according to a fourth embodiment; and

FIG. 8 is a cross-sectional view schematically illustrating the electric storage device according to the fourth embodiment.

### DETAILED DESCRIPTION OF EMBODIMENTS

Embodiments and modifications according to the present disclosure will be described below with reference to the drawings. In the following description, identical parts and components are denoted by the same reference numerals. These parts and components also have the same names and functions. Therefore, a detailed description of these will not be repeated. Note that the embodiments and modifications to be described below may be selectively combined as appropriate.

### First Embodiment

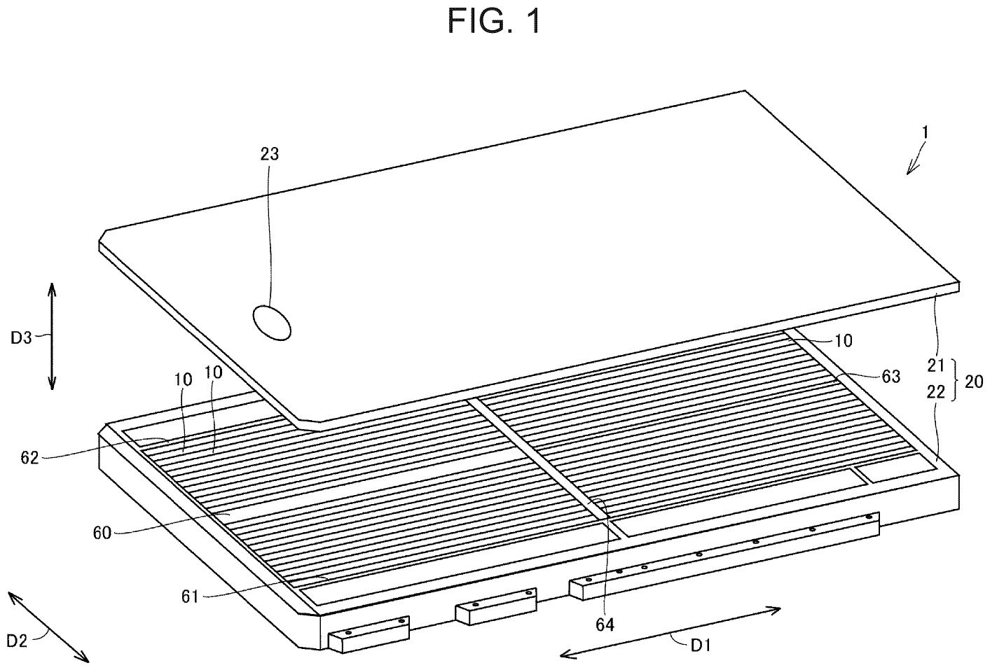

An electric storage device according to a first embodiment will be described with reference to FIGS. 1 to 3. FIG. 1 is a perspective view schematically illustrating the electric storage device according to the first embodiment.

Referring to FIG. 1, an electric storage device 1 according to the first embodiment is installed in a vehicle for use. Examples of the vehicle include a hybrid electric vehicle, a plug-in hybrid electric vehicle, a fuel cell electric vehicle, and a battery electric vehicle. The electric storage device 1 includes a plurality of electric storage cells 10 and a housing case 20 that houses the plurality of electric storage cells 10.

The electric storage cell 10 is a secondary battery, typically a lithium-ion secondary battery. The lithium-ion secondary battery is a battery using lithium as a charge carrier, and can include a general lithium-ion secondary battery with a liquid electrolyte as well as a so-called all-solid-state battery using a solid electrolyte. Note that the electric storage cell 10 is not limited to a lithium-ion secondary battery, and may be formed of a nickel-metal hydride secondary battery or another secondary battery.

The electric storage cell 10 is disposed to extend in a front-rear direction D1 of the vehicle. The plurality of electric storage cells 10 is arranged along a width direction D2 of the vehicle.

The housing case 20 includes an upper case 21, a lower case 22, and a case exhaust valve 23. The lower case 22 includes a bottom plate, a peripheral wall, and a plurality of partition walls 60, 61, 62, 63, 64. The plurality of partition walls 60, 61, 62, 63, 64 partitions the space in the housing case 20 into a plurality of spaces.

The bottom plate is formed in a flat plate shape. The peripheral wall is formed to extend upward from the outer peripheral edge of the bottom plate, and the peripheral wall is formed in an annular shape. The partition walls 60, 61, 62, 63, 64 are provided in the bottom plate. The partition walls 60, 61, 62, 63 are formed to extend in the front-rear direction D1 of the vehicle, and the partition wall 64 is formed to extend in the width direction D2 of the vehicle. The partition wall 64 is disposed in the center of the front-rear direction D1 of the vehicle. The partition wall 60 and the partition wall 63 are disposed in the center of the width direction D2 of the vehicle. The partition wall 60 is disposed on the front side of the partition wall 64, and the partition wall 63 is disposed on the rear side of the partition wall 64. The plurality of electric storage cells 10 is housed in the space formed by assembling the upper case 21 to the lower case 22. FIG. 1 illustrates the electric storage device 1 with the upper case 21 removed.

The case exhaust valve 23 is configured to discharge gas in the housing case 20. The case exhaust valve 23 is provided in the upper case 21.

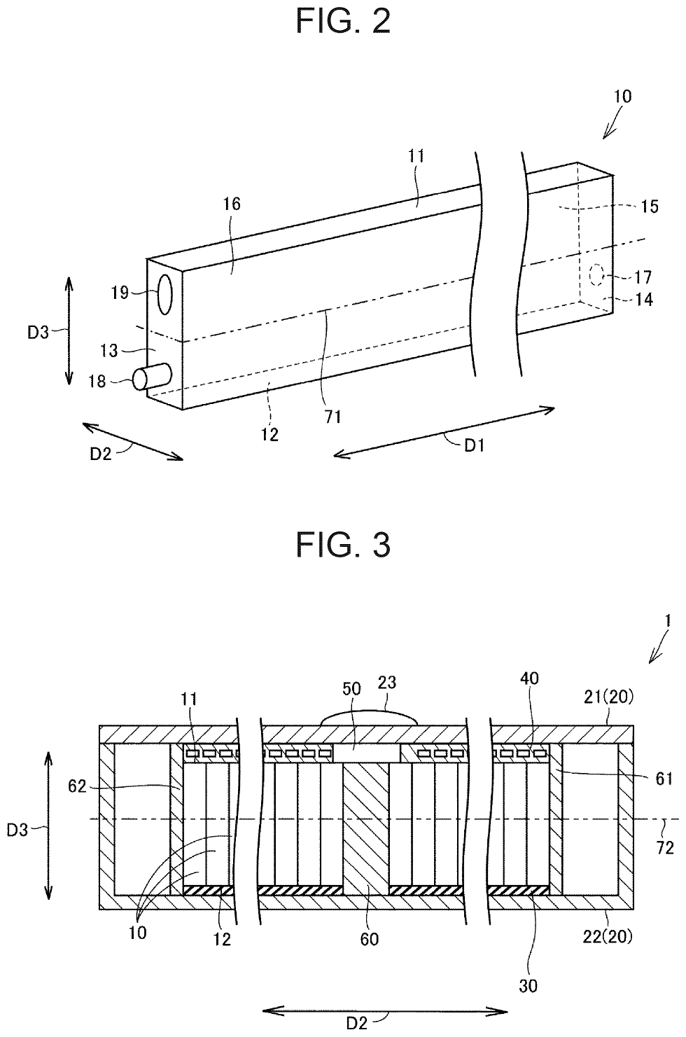

FIG. 2 is a diagram schematically illustrating an example of the electric storage cell 10. Referring to FIG. 2, the electric storage cell 10 includes an upper surface 11, a lower surface 12, a pair of short side surfaces 13, 14, and a pair of long side surfaces 15, 16. The pair of short side surfaces 13, 14 is provided with an interval in the front-rear direction D1 of the vehicle. The pair of long side surfaces 15, 16 is disposed with an interval in the width direction D2 of the vehicle. Each of the pair of long side surfaces 15, 16 is formed to extend in the front-rear direction D1 of the vehicle. Note that the short side surfaces 13, 14 and the long side surfaces 15, 16 are “side surfaces” in the present disclosure.

The electric storage cell 10 further includes a positive electrode terminal 17 and a negative electrode terminal 18. The positive electrode terminal 17 is provided on one surface of the pair of short side surfaces 13, 14, and the negative electrode terminal 18 is provided on the other surface of the pair of short side surfaces 13, 14. In the example illustrated in FIG. 2, the positive electrode terminal 17 is provided on the short side surface 14, and the negative electrode terminal 18 is provided on the short side surface 13. Note that both the positive electrode terminal 17 and the negative electrode terminal 18 may be provided on one surface of the pair of short side surfaces 13, 14.

The electric storage cell 10 further includes a cell exhaust valve 19 that exhausts gas in the electric storage cell 10. The cell exhaust valve 19 is configured to discharge the gas in the electric storage cell 10 to the outside of the electric storage cell 10 when the internal pressure of the electric storage cell 10 increases. The gas discharged from the cell exhaust valve 19 is of high temperature. The cell exhaust valve 19 is provided on a side surface of the electric storage cell 10. More specifically, the cell exhaust valve 19 is provided on one surface of the pair of short side surfaces 13, 14. In the example illustrated in FIG. 2, the cell exhaust valve 19 is provided on the short side surface 13 where the negative electrode terminal 18 is provided. A two-dot chain line 71 indicates the center position of the electric storage cell 10 in a height direction D3 of the electric storage device 1 (cf. FIG. 1). The cell exhaust valve 19 is provided above the center of the electric storage cell 10 in the height direction D3 of the electric storage device 1.

FIG. 3 is a view schematically illustrating a cross section of the electric storage device 1 when the electric storage device 1 is cut in a plane passing through the case exhaust valve 23 and parallel to the short side surface 13 of the electric storage cell 10. In FIG. 3, the hatching showing the cross section of the electric storage cell 10 is omitted in consideration of the legibility of the drawing.

Referring to FIG. 3, a two-dot chain line 72 indicates the center position of the housing case 20 in the height direction D3 of the electric storage device 1. As illustrated in FIG. 3, the case exhaust valve 23 is provided above the center of the housing case 20 in the height direction D3 of the electric storage device 1.

The lower surface 12 of the electric storage cell 10 and the lower case 22 are secured by an adhesive 30. The electric storage device 1 further includes a cooler 40 that cools the electric storage cell 10. The cooler 40 is provided on the electric storage cell 10. More specifically, the cooler 40 is provided along the upper surface 11 in the space between the upper surface 11 of the electric storage cell 10 and the upper case 21. Thus, the cooler 40 is located near the cell exhaust valve 19 (cf. FIG. 2).

The space between the upper surface 11 of the electric storage cell 10 and the upper case 21 includes a space 50 in which the cooler 40 is not provided. The space 50 includes at least a part of a region facing the case exhaust valve 23. The space 50 is formed above the partition wall 60.

Thus, in the electric storage device 1, the cell exhaust valve 19 (cf. FIG. 2), the cooler 40, the space 50, and the case exhaust valve 23 are provided above the center of the housing case 20 in the height direction D3 of the electric storage device 1. The gas discharged from the cell exhaust valve 19 (cf. FIG. 2) moves in the housing case 20 along the short side surface 13 (cf. FIG. 2) and reaches the vicinity of the cooler 40. When the gas fills the housing case 20, the internal pressure in the housing case 20 increases. Thereby, the upper case 21 deforms to inflate upward. On the other hand, the lower case 22 is prevented from deforming because the lower case 22 and the electric storage cells 10 are secured by the adhesive 30. By the upper case 21 deforming to inflate upward, a gap is formed between the upper case 21 and the cooler 40, and the gas accumulates in this gap.

Thereafter, when the internal pressure in the housing case 20 becomes equal to or higher than a predetermined pressure, the case exhaust valve 23 opens, and the gas in the housing case 20 is discharged to the outside. At this time, since the case exhaust valve 23 is provided in the upper case 21, and the gas has accumulated between the upper case 21 and the cooler 40, the gas is satisfactorily exhausted to the outside through the case exhaust valve 23. Specifically, the gas discharged from the cell exhaust valve 19 moves to the space 50 through the gap and is discharged from the case exhaust valve 23 to the outside of the housing case 20 through the space 50. Therefore, according to the electric storage device 1, the exhaust efficiency is improved in discharging the gas, discharged from the cell exhaust valve 19, to the outside of the housing case 20 from the case exhaust valve 23.

Here, the gas discharged from the cell exhaust valve 19 is of high temperature, and the gas accumulates upward in the housing case 20 as described above. Meanwhile, since the cooler 40 is disposed on the upper surface 11 of each electric storage cell 10, the upper surface 11 of the electric storage cells 10 can be prevented from deteriorating due to heat from the high-temperature gas. In addition, since the partition wall 60 is located below the space 50, when the gas flows through the space 50, the electric storage cell 10 is prevented from being exposed to the high-temperature gas.

In the electric storage device 1, the cooler 40 is provided near the cell exhaust valve 19. Therefore, according to the electric storage device 1, the gas discharged from the cell exhaust valve 19 is cooled relatively quickly. In the electric storage device 1, the cooler 40 is provided in the path of the gas discharged from the cell exhaust valve 19. Thus, the gas discharged from the cell exhaust valve 19 is gradually cooled until the gas is directed to the case exhaust valve 23. Therefore, according to the electric storage device 1, the electric storage cell 10 and the upper case 21 are prevented from damage caused by the high-temperature gas discharged from the cell exhaust valve 19.

As described above, in the electric storage device 1 according to the first embodiment, the case exhaust valve 23 is provided above the center of the housing case 20 in the height direction D3 of the electric storage device 1 and the cell exhaust valve 19 is provided above the center of the electric storage cell 10 in the height direction D3 of the electric storage device 1. With such a configuration, an exhaust path that the gas discharged from the cell exhaust valve 19 follows before being discharged from the case exhaust valve 23 to the outside of the housing case 20 can be made shorter than when the cell exhaust valve 19 is provided below the center of the electric storage cell 10 in the height direction D3 of the electric storage device 1. Therefore, according to the electric storage device 1 of the first embodiment, when the cell exhaust valve 19 is provided on the side surface of the electric storage cell 10, the exhaust efficiency for discharging the gas, discharged from the cell exhaust valve 19, to the outside of the housing case 20 from the case exhaust valve 23 is improved. According to the electric storage device 1 of the first embodiment, the exhaust path can be shortened, thus reducing an area where the high-temperature gas discharged from the cell exhaust valve 19 comes into contact with the electric storage cell 10.

In the electric storage device 1 according to the first embodiment, the cell exhaust valve 19 is provided on one surface (e.g., short side surface 13) of the pair of short side surfaces 13, 14 of the electric storage cell 10. With such a configuration, the gas discharged from the cell exhaust valve 19 rises in the housing case 20 along the short side surface 13. If the cell exhaust valve 19 is provided on one surface of the pair of long side surfaces 15, 16 of the electric storage cell 10, the gas discharged from the cell exhaust valve 19 rises in the housing case 20 along the long side surface 15 or the long side surface 16. Thus, when the cell exhaust valve 19 is provided on one surface of the pair of long side surfaces 15, 16 of the electric storage cell 10, the area where the high-temperature gas discharged from the cell exhaust valve 19 comes into contact with the electric storage cell 10 increases. However, in the electric storage device 1 according to the first embodiment, the cell exhaust valve 19 is provided on one surface of the pair of short side surfaces 13, 14 of the electric storage cell 10. Therefore, according to the electric storage device 1 of the first embodiment, the area where the high-temperature gas discharged from the cell exhaust valve 19 comes into contact with the electric storage cell 10 can be reduced more than when the cell exhaust valve 19 is provided on one surface of the pair of long side surfaces 15, 16 of the electric storage cell 10.

In the electric storage device 1 according to the first embodiment, the lower surface 12 of the electric storage cell 10 and the lower case 22 are secured by the adhesive 30. In the electric storage device 1 according to the first embodiment, the gas discharged from the cell exhaust valve 19 rises in the housing case 20 along the short side surface 13 and is discharged from the case exhaust valve 23 to the outside of the housing case 20 through the space 50. Therefore, according to the electric storage device 1 of the first embodiment, the high-temperature gas discharged from the cell exhaust valve 19 can be prevented from coming into contact with the adhesive 30.

### Second Embodiment

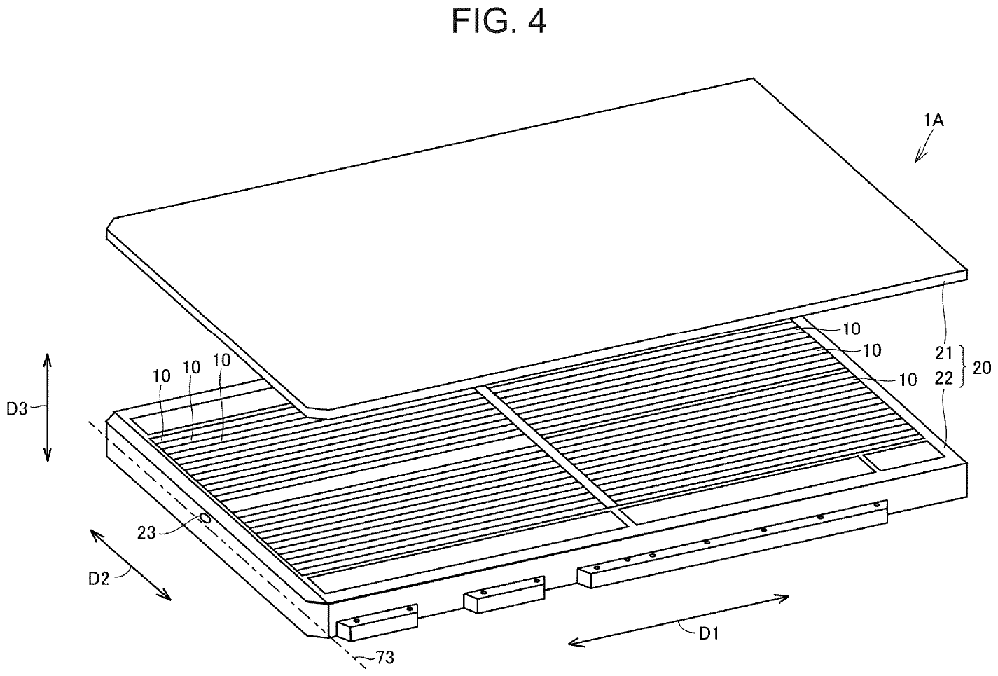

An electric storage device according to a second embodiment will be described with reference to FIG. 4. FIG. 4 is a perspective view schematically illustrating the electric storage device according to the second embodiment.

Referring to FIG. 4, an electric storage device 1A according to the second embodiment differs from the electric storage device 1 according to the first embodiment (cf. FIG. 1) in the position of the case exhaust valve 23. In the electric storage device 1A according to the second embodiment, the case exhaust valve 23 is provided in the lower case 22. In other respects, the electric storage device 1A according to the second embodiment is the same as the electric storage device 1 according to the first embodiment (cf. FIG. 1), and hence the description will not be repeated.

FIG. 4 illustrates the electric storage device 1A with the upper case 21 removed. A two-dot chain line 73 indicates the center position of the housing case 20 in a height direction D3 of the electric storage device 1A. In the electric storage device 1A, the case exhaust valve 23 is provided above the center of the housing case 20 in the height direction D3 of the electric storage device 1A. That is, in the electric storage device 1A, the case exhaust valve 23 is provided above the center of the lower case 22 in the height direction D3 of the electric storage device 1A. The gas discharged from the cell exhaust valve 19 (cf. FIG. 2) moves along the short side surface 13 (cf. FIG. 2) and is discharged from the case exhaust valve 23 (cf. FIG. 4) to the outside of the housing case 20.

As described above, in the electric storage device 1A according to the second embodiment, the case exhaust valve 23 is provided above the center of the housing case 20 in the height direction D3 of the electric storage device 1A, and the cell exhaust valve 19 is provided above the center of the electric storage cell 10 in the height direction D3 of the electric storage device 1A. With such a configuration, an exhaust path that the gas discharged from the cell exhaust valve 19 follows before being discharged from the case exhaust valve 23 to the outside of the housing case 20 can be made shorter than when the cell exhaust valve 19 is provided below the center of the electric storage cell 10 in the height direction D3 of the electric storage device 1A. Therefore, according to the electric storage device 1A of the second embodiment, when the cell exhaust valve 19 is provided on the side surface of the electric storage cell 10, the exhaust efficiency for discharging the gas, discharged from the cell exhaust valve 19, to the outside of the housing case 20 from the case exhaust valve 23 is improved. According to the electric storage device 1A of the second embodiment, the exhaust path can be shortened, thus reducing an area where the high-temperature gas discharged from the cell exhaust valve 19 comes into contact with the electric storage cell 10.

In the electric storage device 1A according to the second embodiment, the cell exhaust valve 19 is provided on one surface (e.g., short side surface 13) of the pair of short side surfaces 13, 14 of the electric storage cell 10. With such a configuration, the gas discharged from the cell exhaust valve 19 moves along the short side surface 13 and is discharged from the case exhaust valve 23 to the outside of the housing case 20. If the cell exhaust valve 19 is provided on one surface of the pair of long side surfaces 15, 16 of the electric storage cell 10, the gas discharged from the cell exhaust valve 19 moves in the housing case 20 along the long side surface 15 or the long side surface 16. Thus, when the cell exhaust valve 19 is provided on one surface of the pair of long side surfaces 15, 16 of the electric storage cell 10, the area where the high-temperature gas discharged from the cell exhaust valve 19 comes into contact with the electric storage cell 10 increases. However, in the electric storage device 1A according to the second embodiment, the cell exhaust valve 19 is provided on one surface of the pair of short side surfaces 13, 14 of the electric storage cell 10. Therefore, according to the electric storage device 1A of the second embodiment, the area where the high-temperature gas discharged from the cell exhaust valve 19 comes into contact with the electric storage cell 10 can be reduced more than when the cell exhaust valve 19 is provided on one surface of the pair of long side surfaces 15, 16 of the electric storage cell 10.

In the electric storage device 1A according to the second embodiment, the lower surface 12 of the electric storage cell 10 and the lower case 22 are secured by the adhesive 30. In the electric storage device 1A according to the second embodiment, the gas discharged from the cell exhaust valve 19 moves along the short side surface 13 and is discharged from the case exhaust valve 23 to the outside of the housing case 20. Therefore, according to the electric storage device 1A of the second embodiment, the high-temperature gas discharged from the cell exhaust valve 19 can be prevented from coming into contact with the adhesive 30.

### Third Embodiment

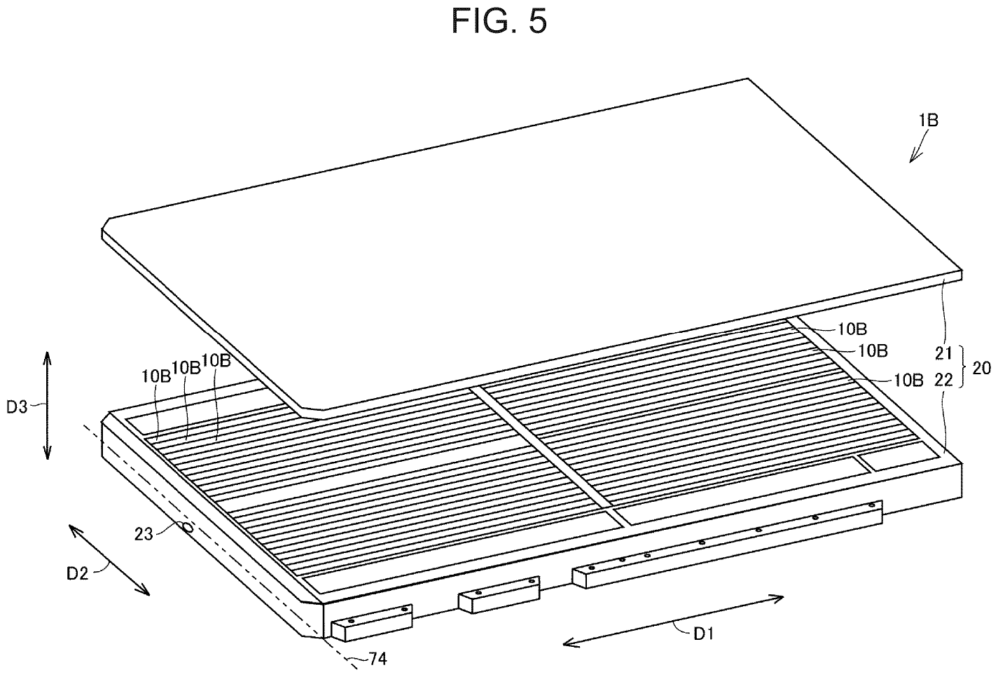

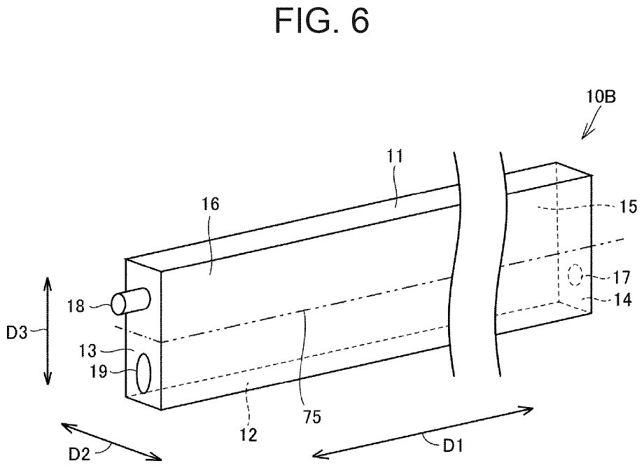

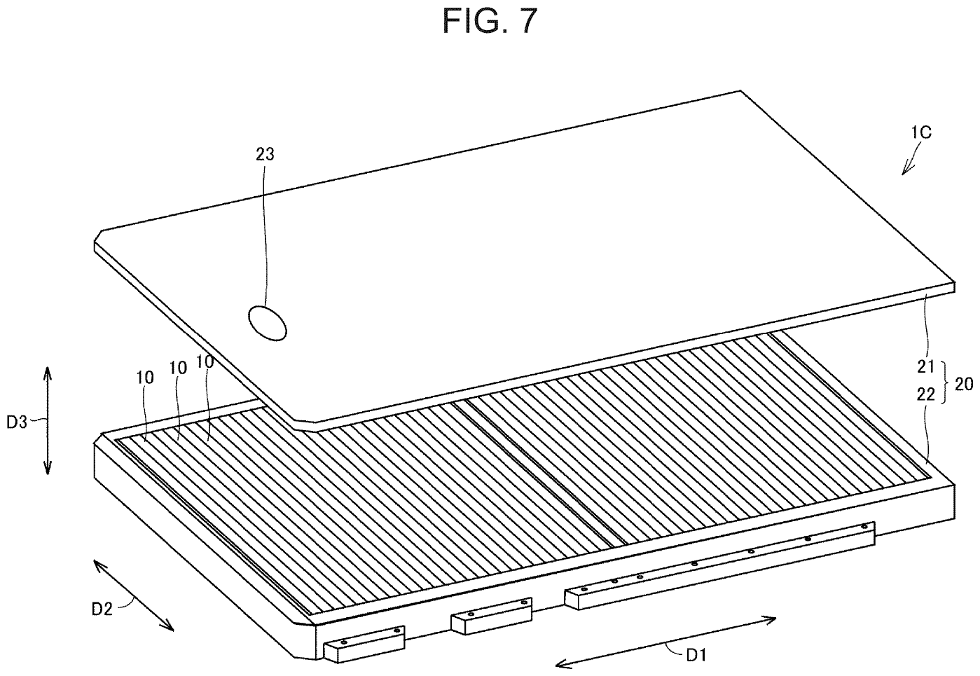

An electric storage device according to a third embodiment will be described with reference to FIGS. 5 and 6. FIG. 5 is a perspective view schematically illustrating the electric storage device according to the third embodiment.

Referring to FIG. 5, an electric storage device 1B according to the third embodiment differs from the electric storage device 1 according to the first embodiment (cf. FIG. 1) in two points. The first point is that the electric storage device 1B according to the third embodiment includes a plurality of electric storage cells 10B instead of the plurality of electric storage cells 10 (cf. FIG. 1). The second point is the position of the case exhaust valve 23. In the electric storage device 1B according to the third embodiment, the case exhaust valve 23 is provided in the lower case 22. In other respects, the electric storage device 1B according to the third embodiment is the same as the electric storage device 1 according to the first embodiment (cf. FIG. 1), and hence the description will not be repeated.

FIG. 5 illustrates the electric storage device 1B with the upper case 21 removed. The plurality of electric storage cells 10B is housed in the housing case 20. The electric storage cell 10B is disposed to extend in the front-rear direction D1 of the vehicle. The plurality of electric storage cells 10B is arranged along the width direction D2 of the vehicle.

A two-dot chain line 74 indicates the center position of the lower case 22 in a height direction D3 of the electric storage device 1B. In the electric storage device 1B, the case exhaust valve 23 is provided below the center of the lower case 22 in the height direction D3 of the electric storage device 1B. That is, in the electric storage device 1B, the case exhaust valve 23 is provided below the center of the housing case 20 in the height direction D3 of the electric storage device 1B.

FIG. 6 is a diagram schematically illustrating an example of the electric storage cell 10B. The electric storage cell 10B differs from the electric storage cell 10 described above (cf. FIG. 2) in the positions of the cell exhaust valve 19 and the negative electrode terminal 18. In other respects, the electric storage cell 10B is the same as the electric storage cell 10 described above (cf. FIG. 2), and hence the description will not be repeated.

The cell exhaust valve 19 is provided on a side surface of the electric storage cell 10B. More specifically, the cell exhaust valve 19 is provided on one surface of the pair of short side surfaces 13, 14. In the example illustrated in FIG. 6, the cell exhaust valve 19 is provided on the short side surface 13 where the negative electrode terminal 18 is provided. A two-dot chain line 75 indicates the center position of the electric storage cell 10B in the height direction D3 of the electric storage device 1B (cf. FIG. 5). The cell exhaust valve 19 is provided below the center of the electric storage cell 10B in the height direction D3 of the electric storage device 1B. The negative electrode terminal 18 is provided within the short side surface 13 at a position that does not overlap the cell exhaust valve 19.

Note that both the positive electrode terminal 17 and the negative electrode terminal 18 may be provided on one surface of the pair of short side surfaces 13, 14.

As described above, in the electric storage device 1B according to the third embodiment, the case exhaust valve 23 is provided below the center of the housing case 20 in the height direction D3 of the electric storage device 1B, and the cell exhaust valve 19 is provided below the center of the electric storage cell 10B in the height direction D3 of the electric storage device 1B. With such a configuration, an exhaust path that the gas discharged from the cell exhaust valve 19 follows before being discharged from the case exhaust valve 23 to the outside of the housing case 20 can be made shorter than when the cell exhaust valve 19 is provided above the center of the electric storage cell 10B in the height direction D3 of the electric storage device 1B. Therefore, according to the electric storage device 1B of the third embodiment, when the cell exhaust valve 19 is provided on the side surface of the electric storage cell 10B, the exhaust efficiency for discharging the gas, discharged from the cell exhaust valve 19, to the outside of the housing case 20 from the case exhaust valve 23 is improved. According to the electric storage device 1B of the third embodiment, the exhaust path can be shortened, thus reducing an area where the high-temperature gas discharged from the cell exhaust valve 19 comes into contact with the electric storage cell 10B.

In the electric storage device 1B according to the third embodiment, the cell exhaust valve 19 is provided on one surface (e.g., short side surface 13) of the pair of short side surfaces 13, 14 of the electric storage cell 10B. With such a configuration, the gas discharged from the cell exhaust valve 19 moves along the short side surface 13 and is discharged from the case exhaust valve 23 to the outside of the housing case 20. If the cell exhaust valve 19 is provided on one surface of the pair of long side surfaces 15, 16 of the electric storage cell 10B, the gas discharged from the cell exhaust valve 19 moves in the housing case 20 along the long side surface 15 or the long side surface 16. Thus, when the cell exhaust valve 19 is provided on one surface of the pair of long side surfaces 15, 16 of the electric storage cell 10B, the area where the high-temperature gas discharged from the cell exhaust valve 19 comes into contact with the electric storage cell 10B increases. However, in the electric storage device 1B according to the third embodiment, the cell exhaust valve 19 is provided on one surface of the pair of short side surfaces 13, 14 of the electric storage cell 10B. Therefore, according to the electric storage device 1B of the third embodiment, the area where the high-temperature gas discharged from the cell exhaust valve 19 comes into contact with the electric storage cell 10B can be reduced more than when the cell exhaust valve 19 is provided on one surface of the pair of long side surfaces 15, 16 of the electric storage cell 10B.

In the electric storage device 1B according to the third embodiment, the lower surface 12 of the electric storage cell 10B and the lower case 22 are secured by the adhesive 30. In the electric storage device 1B according to the third embodiment, the gas discharged from the cell exhaust valve 19 moves along the short side surface 13 and is discharged from the case exhaust valve 23 to the outside of the housing case 20. Therefore, according to the electric storage device 1B of the third embodiment, the high-temperature gas discharged from the cell exhaust valve 19 can be prevented from coming into contact with the adhesive 30.

### Fourth Embodiment

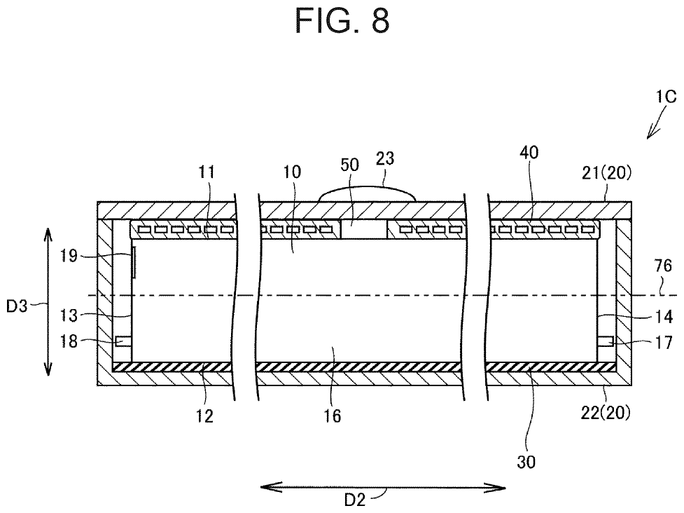

Referring to FIGS. 7, 8, and 2, an electric storage device according to the fourth embodiment will be described. FIG. 7 is a perspective view schematically illustrating the electric storage device according to the fourth embodiment. FIG. 8 is a cross-sectional view schematically illustrating an electric storage device according to the fourth embodiment.

Referring to FIG. 7, an electric storage device 1C according to the fourth embodiment differs from the electric storage device 1 according to the first embodiment (cf. FIG. 1) in the arrangement of the electric storage cells 10. In the electric storage device 1C according to the fourth embodiment, the electric storage cell 10 is disposed to extend in the width direction D2 of the vehicle, and the plurality of electric storage cells 10 is arranged along the front-rear direction D1 of the vehicle. In other respects, the electric storage device 1C according to the fourth embodiment is the same as the electric storage device 1 according to the first embodiment (cf. FIG. 1).

Referring to FIG. 8, FIG. 8 schematically illustrates a cross section of the electric storage device 1C when the electric storage device 1C is cut in a plane passing through the case exhaust valve 23 and parallel to the long side surface 16 of the electric storage cell 10. In FIG. 8, the hatching showing the cross sections of the electric storage cell 10, the cell exhaust valve 19, the positive electrode terminal 17, and the negative electrode terminal 18 is omitted in consideration of the legibility of the drawing.

Referring to FIGS. 2 and 8, in the electric storage device 1C according to the fourth embodiment, the pair of short side surfaces 13, 14 of the electric storage cell 10 is provided with an interval in the width direction D2 of the vehicle, and the pair of long side surfaces 15, 16 is disposed with an interval in the front-rear direction D1 of the vehicle. In the electric storage device 1C according to the fourth embodiment, each of the pair of long side surfaces 15, 16 is formed to extend in the width direction D2 of the vehicle. In the electric storage device 1C according to the fourth embodiment as well, the cell exhaust valve 19 is provided on one surface of the pair of short side surfaces 13, 14. In the example illustrated in FIGS. 2 and 8, the cell exhaust valve 19 is provided on the short side surface 13.

Referring to FIG. 8, a two-dot chain line 76 indicates the center position of the housing case 20 in a height direction D3 of the electric storage device 1C. The case exhaust valve 23 is provided above the center of the housing case 20 in the height direction D3 of the electric storage device 1C. That is, the case exhaust valve 23 is provided above the center of the lower case 22 in the height direction D3 of the electric storage device 1C. The cell exhaust valve 19 is provided above the center of the electric storage cell 10 in the height direction D3 of the electric storage device 1C.

Similarly to the electric storage device 1 (cf. FIG. 1), the electric storage device 1C includes a cooler 40 for cooling the electric storage cell 10. The cooler 40 is provided on the electric storage cell 10. More specifically, the cooler 40 is provided along the upper surface 11 in the space between the upper surface 11 of the electric storage cell 10 and the upper case 21. Thus, the cooler 40 is located near the cell exhaust valve 19.

The space between the upper surface 11 of the electric storage cell 10 and the upper case 21 includes a space 50 in which the cooler 40 is not provided. The space 50 includes at least a part of a region facing the case exhaust valve 23. The lower surface 12 of the electric storage cell 10 and the lower case 22 are secured by an adhesive 30.

As described above, in the electric storage device 1C, the cell exhaust valve 19, the cooler 40, the space 50, and the case exhaust valve 23 are provided above the center of the housing case 20 in the height direction D3 of the electric storage device 1C. Therefore, in the electric storage device 1C, similarly to the electric storage device 1, the gas is satisfactorily exhausted to the outside through the case exhaust valve 23.

In the electric storage device 1C as well, since the cooler 40 is provided on the upper surface 11 of each electric storage cell 10, the upper surface 11 of each electric storage cell 10 can be prevented from deteriorating due to heat from the high-temperature gas.

In the electric storage device 1C as well, the case exhaust valve 23 is provided above the center of the housing case 20 in the height direction D3 of the electric storage device 1C, and the cell exhaust valve 19 is provided above the center of the electric storage cell 10 in the height direction D3 of the electric storage device 1C. Therefore, it is possible to shorten an exhaust path that the gas discharged from the cell exhaust valve 19 follows before being discharged from the case exhaust valve 23 to the outside of the housing case 20.

### First Modification

Referring to FIG. 8, in the electric storage device 1C, the cell exhaust valve 19, the cooler 40, the space 50, and the case exhaust valve 23 may be provided below the center of the housing case 20 in the height direction D3 of the electric storage device 1C. A specific configuration of the electric storage device in such an instance is as follows.

The case exhaust valve 23 is provided below the center of the housing case 20 in a height direction D3 of the electric storage device. That is, the case exhaust valve 23 is provided below the center of the lower case 22 in the height direction D3 of the electric storage device. As an example, the case exhaust valve 23 is provided in the lower case 22.

The cell exhaust valve 19 is provided below the center of the electric storage cell 10 in the height direction D3 of the electric storage device. The cooler 40 is provided along the lower surface 12 in the space between the lower surface 12 of the electric storage cell 10 and the lower case 22. Thus, the cooler 40 is located near the cell exhaust valve 19. The space between the lower surface 12 of the electric storage cell 10 and the lower case 22 includes a space 50 in which the cooler 40 is not provided. The space 50 includes at least a part of a region facing the case exhaust valve 23. The upper surface 11 of the electric storage cell 10 and the upper case 21 are secured by an adhesive 30.

In the electric storage device with such a configuration, when the gas discharged from the cell exhaust valve 19 fills the housing case 20, the lower case 22 deforms, thereby forming a gap between the lower case 22 and the cooler 40, and the gas accumulates in this gap. Thereafter, when the internal pressure in the housing case 20 becomes equal to or higher than a predetermined pressure, the case exhaust valve 23 opens, and the gas in the housing case 20 is discharged to the outside. At this time, since the case exhaust valve 23 is provided in the lower case 22, and the gas has accumulated between the lower case 22 and the cooler 40, the gas is satisfactorily exhausted to the outside through the case exhaust valve 23. Therefore, the electric storage device with such a configuration also exhibits a similar effect to that of the electric storage device 1C.

Such a configuration may also be applied to the electric storage device 1 (cf. FIG. 3). In such an instance, a similar effect to that of the electric storage device 1 is exhibited.

### Second Modification

In the electric storage device 1A according to the second embodiment as well, the electric storage cell 10 may be disposed to extend in the width direction D2 of the vehicle, and the plurality of electric storage cells 10 may be arranged along the front-rear direction D1 of the vehicle. Referring to FIG. 2, in such an instance, the pair of short side surfaces 13, 14 of the electric storage cells 10 is provided with an interval in the width direction D2 of the vehicle, and the pair of long side surfaces 15, 16 is disposed with an interval in the front-rear direction D1 of the vehicle. Each of the pair of long side surfaces 15, 16 is formed to extend in the width direction D2 of the vehicle. The cell exhaust valve 19 is provided on one surface of the pair of short side surfaces 13, 14. Even in such an instance, a similar effect to that described in the second embodiment can be achieved.

In the electric storage device 1B according to the third embodiment as well, the electric storage cell 10B may be disposed to extend in the width direction D2 of the vehicle, and the plurality of electric storage cells 10B may be arranged along the front-rear direction D1 of the vehicle. Referring to FIG. 6, in such an instance, the pair of short side surfaces 13, 14 of the electric storage cell 10B is provided with an interval in the width direction D2 of the vehicle, and the pair of long side surfaces 15, 16 is disposed with an interval in the front-rear direction D1 of the vehicle. Each of the pair of long side surfaces 15, 16 is formed to extend in the width direction D2 of the vehicle. The cell exhaust valve 19 is provided on one surface of the pair of short side surfaces 13, 14. Even in such an instance, a similar effect to that described in the third embodiment above is achieved.

### Third Modification

Referring to FIG. 2, the cell exhaust valve 19 may be provided on one surface of the pair of long side surfaces 15, 16 of the electric storage cell 10. Referring to FIG. 6, the cell exhaust valve 19 may be provided on one surface of the pair of long side surfaces 15, 16 of the electric storage cell 10B.

The embodiments disclosed here should be considered in all respects illustrative and not restrictive. The scope of the present disclosure is indicated by the claims, not by the above description, and is intended to include all changes within the meaning and scope of the claims and their equivalents.

What is claimed is:

1. An electric storage device comprising:
a plurality of electric storage cells; and
a housing case that houses the plurality of electric storage cells,
wherein
each of the plurality of storage cells includes a cell exhaust valve that is provided on a side surface of the electric storage cell and exhausts gas in the electric storage cell,
the storage case includes a lower case, an upper case, and a case exhaust valve that exhausts gas in the storage case,
the case exhaust valve is provided above or below a center of the storage case in a height direction of the electric storage device,
when the case exhaust valve is provided above the center of the storage case, the cell exhaust valve is provided above the center of the electric storage cell in the height direction, and
when the case exhaust valve is provided below the center of the housing case, the cell exhaust valve is provided below the center of the electric storage cell in the height direction.

2. The electric storage device according to claim 1, wherein the case exhaust valve is provided above the center of the lower case or in the upper case, and the cell exhaust valve is provided above the center of the electric storage cell in the height direction.

3. The electric storage device according to claim 1, wherein the case exhaust valve is provided below the center of the lower case, and the cell exhaust valve is provided below the center of the electric storage cell in the height direction.

4. The electric storage device according to claim 1, wherein
the electric storage device is installed in a vehicle,
each of the plurality of electric storage cells includes an upper surface, a lower surface, a pair of short side surfaces, and a pair of long side surfaces,
the pair of long side surfaces is disposed with an interval in a width direction of the vehicle,
each of the pair of long side surfaces is formed to extend in a front-rear direction of the vehicle,
the pair of short side surfaces is provided with an interval in the front-rear direction of the vehicle, and
the cell exhaust valve is provided on one surface of the pair of short side surfaces.

5. The electric storage device according to claim 1, wherein
the electric storage device is installed in a vehicle,
each of the plurality of electric storage cells includes an upper surface, a lower surface, a pair of short side surfaces, and a pair of long side surfaces,
the pair of long side surfaces is disposed with an interval in a front-rear direction of the vehicle,
each of the pair of long side surfaces is formed to extend in a width direction of the vehicle,
the pair of short side surfaces is provided with an interval in the width direction of the vehicle, and
the cell exhaust valve is provided on one surface of the pair of short side surfaces.

6. The electric storage device according to claim 4, wherein the lower surface and the lower case are secured by an adhesive.
